(19) United States
(12) Patent Application Publication
(10) Pub. No.: US 2014/0111542 A1
(43) Pub. Date: Apr. 24, 2014

(54) Platform for recognising text using mobile devices with a built-in device video camera and automatically retrieving associated content based on the recognised text

(71) Applicant: James Yoong-Siang Wan, Sydney (AU)

(72) Inventor: James Yoong-Siang Wan, Sydney (AU)

(21) Appl. No.: 13/656,708

(22) Filed: Oct. 20, 2012

(51) Int. Cl. G09G 5/00

(52) U.S. Cl. 345/633

(57) ABSTRACT

A platform for recognising text using mobile devices with a built-in device video camera and automatically retrieving associated content based on the recognised text.

### TECHNICAL FIELD

The invention concerns a platform for recognising text using mobile devices with a built-in device video camera and automatically retrieving associated content based on the recognised text.

### BACKGROUND OF THE INVENTION

1 billion smart phones are expected by 2013. The main advantage of smart phones over previous types of mobile phones is that they have 3G connectivity to wirelessly access the Internet whenever there is a mobile phone signal detected. Also, smart phones have the computational processing power to execute more complex applications and offer greater user interaction primarily through a capacitive touchscreen panel, compared to previous types of mobile phones.

In a recent survey, 69% of people research products online before going to the store to purchase. However, prior researching does not provide the same experience as researching while at the store which enables the customer to purchase immediately. Also in the survey, 61% of people want to be able to scan bar codes and access information on other store's prices. This is for searching similar products or price comparison. However, this functionality is not offered on a broad basis at this time. Reviews sites may offer alternative products (perhaps better) than the one the user is interested in.

Casual dining out in urban areas is popular, especially in cities like Hong Kong where people have less time to cook at home. People may read magazines, books or newspapers for suggestions on new or existing dining places to try. In addition, they may visit Internet review sites which have user reviews on many dining places before they decide to eat at a restaurant. This prior checking may be performed indoors at home or in the office using an Internet browser from a desktop or laptop computer, or alternatively on their smart phone if outdoors. In either case, the user must manually enter details of the restaurant in a search engine or a review site via a physical or virtual keyboard, and then select from a list of possible results for the reviews on the specific restaurant. This is cumbersome in terms of the user experience because the manual entry of the restaurant's name takes time. Also, because the size of the screen of the smart phone is not very large, scrolling through the list of possible results may take time. The current process requires a lot of user interaction and time between the user and the text entry application of the phone and the search engine. This problem is exacerbated in situations where people are walking outdoors in a food precinct and there are a lot of restaurants to choose from. People may wish to check reviews of or possible discounts offered by the many restaurants they pass by in the food precinct before deciding to eat at one. The time taken to manually enter each one of the restaurant's name into their phone may be too daunting or inconvenient for it to be attempted.

A similar problem also exists when customers are shopping for certain goods, especially commoditised goods such as electrical appliances, fast moving consumer package goods and clothing. When customers are buying on price alone, the priority is to find the lowest price from a plurality of retailers operating in the market. Therefore, price comparison websites have been created to fulfill this purpose. Again, the problem of manual entry of product and model names using a physical or virtual keyboard is time consuming and inconvenient for a customer, especially when they are already at a shop browsing at goods for purchase. The customer needs to know if the same item can be purchased at a lower price elsewhere (preferably, from an Internet seller or a shop nearby), and if not, the customer can purchase the product at the shop they are currently at, and not waste any further time.

Currently, there are advertising agencies charging approximately a HKD$10,000 flat fee for businesses to incorporate a Quick Response (QR) code on their outdoor advertisements for a three month period. When a user takes a still image containing this QR code using their mobile phone, the still image is processed to identify the QR code and subsequently retrieve the relevant record of the business. The user then selects to be directed to digital content specified by the business's record. The digital content is usually an electronic brochure/flyer or a video.

However, this process is cumbersome as it requires businesses to work closely with the advertising agency in order to place the QR code at a specific position of the outdoor advertisement. This wastes valuable advertising space, and the QR code only serves a single purpose to small percentage of passer bys and therefore has no significance to the majority of passer bys. It is also cumbersome in terms of the user experience. Users need to be educated on which mobile application to download and be used for a specific type of QR code they see on an outdoor advertisement. Also, it requires the user to take a still image, wait some time for the still image to be processed, then manually switch the screen to the business's website. Furthermore, if the still image is not captured correctly or clearly, the QR code cannot be recognised and the user will become frustrated at having to take still images over and over again manually by pressing the virtual shutter button on their phone and waiting each time to see if the QR code has been correctly identified. Eventually, the user will give up after several failed attempts.

A mobile application called Google™ Goggles analyses a still image captured by a camera phone. The still image is transmitted to a server and image processing is performed to identify what the still image is or anything that is contained in the still image. However, there is at least a five second delay to wait for transmission and processing, and in many instances, nothing is recognised in the still image.

Therefore it is desirable to provide a platform, method and mobile application to ameliorate at least some of the problems identified above, and improve and enhance the user experience as well as potentially increasing the brand awareness and revenue of businesses that use the platform.

### SUMMARY OF THE INVENTION

In a first preferred aspect, there is provided a platform for recognising text using mobile devices with a built-in device video camera and automatically retrieving associated content based on the recognised text, the platform comprising:
a database for storing machine-encoded text and associated content corresponding to the machine-encoded text; and
an Optical Character Recognition (OCR) engine for detecting the presence of text in a live video feed captured by the built-in device video camera in real-time, and converting the detected text into machine-encoded text in real-time; and
a mobile application executed by the mobile device, the mobile application including: a display module for displaying the live video feed on a screen of the mobile device; and a content retrieval module for retrieving the associated content by querying the database based on the machine-encoded text converted by the OCR engine;
wherein the retrieved associated content is superimposed in the form of Augmented Reality (AR) content on the live video feed using the display module; and the detection and conversion by the OCR engine and the superimposition of the AR content is performed without user input to the mobile application.

The associated content may be at least one menu item that when selected by a user, enables at least one web page to be opened automatically.

The database may be stored on the mobile device, or remotely stored and accessed via the Internet.

The mobile application may have at least one graphical user interface (GUI) component to enable a user to:
indicate language of text to be detected in the live video feed;
manually set geographic location to reduce the number of records to be searched in the database,
indicate at least one sub-application to reduce the number of records to be searched in the database,
view history of detected text, or
view history of associated content selected by the user.

The sub-application may be any one from the group consisting of: place and product.

The query of database may further comprise geographic location obtained from a Global Positioning Satellite receiver (GPSR) of the mobile device.

The query of database may further comprise geographic location and mode.

The display module may display a re-sizable bounding box around the detected text to limit a Region of Interest (ROI) in the live video feed.

The position of the superimposed associated content may be relative to the position of the detected text in the live video feed.

The mobile application may further include the OCR engine, or the OCR engine may be provided in a separate mobile application that communicates with the mobile application.

The OCR engine may assign a higher priority for detecting the presence of text located in an area at a central region of the live video feed.

The OCR engine may assign a higher priority for detecting the presence of text for text markers that are aligned relative to a single imaginary straight line, with substantially equal spacing between individual characters and substantially equal spacing between groups of characters, and with the substantially the same font.

The OCR engine may assign a higher priority for detecting the presence of text for text markers that are the largest size in the live video feed.

The OCR engine may assign a lower priority for detecting the presence of text for image features that are aligned relative to a regular geometric shape of any one from the group consisting of: curve, arc and circle.

The OCR engine may convert the detected text into machine-encoded text based on a full or partial match with machine-encoded text stored in the database.

The machine-encoded text may be in Unicode format or Universal Character Set.

The text markers may include any one from the group consisting of: spaces, edges, colour, and contrast.

The database may store location data and at least one sub-application corresponding to the machine-encoded text.

The platform may further comprise a web service to enable a third party developer to modify the database or create a new database.

The mobile application may further include a markup language parser to enable a third party developer to specify AR content in response to the machine-encoded text converted by the OCR engine.

Information may be transmitted to a server containing non-personally identifiable information about a user, geographic location of the mobile device, time of detected text conversion, machine-encoded text that have been converted and the menu item that was selected, before the server re-directs the user to at least one the web page.

In a second aspect, there is provided a mobile application executed by a mobile device for recognising text using a built-in device video camera of the mobile device and automatically retrieving associated content based on the recognised text, the application comprising:
a display module for displaying a live video feed captured by the built-in device video camera in real-time on a screen of the mobile device; and
a content retrieval module for retrieving the associated content from a database for storing machine-encoded text and associated content corresponding to the machine-encoded text by querying the database based on the machine-encoded text converted by an Optical Character Recognition (OCR) engine for detecting the presence of text in the live video feed captured and converting the detected text into machine-encoded text in real-time;
wherein the retrieved associated content is superimposed in the form of Augmented Reality (AR) content on the live video feed using the display module; and the detection and conversion by the OCR engine and the superimposition of the AR content is performed without user input to the mobile application.

In a third aspect, there is provided a computer-implemented method, comprising: employing a processor executing computer-readable instructions on a mobile device that, when executed by the processor, cause the processor to perform:
detecting the presence of text in a live video feed captured by a built-in device video camera of the mobile device in real-time;
converting the detected text into machine-encoded text;
displaying the live video feed on a screen of the mobile device;
retrieving the associated content by querying a database for storing machine-encoded text and associated content corresponding to the machine-encoded text based on the converted machine-encoded text; and
superimposing the retrieved associated content in the form of Augmented Reality (AR) content on the live video feed;
wherein the steps of detection, conversion and superimposition are performed without user input to the mobile application.

In a fourth aspect, there is provided a mobile device for recognising text using and automatically retrieving associated content based on the recognised text, the device comprising:
a built-in device video camera to capture a live video feed;
a screen to display the live video feed; and
a processor to execute computer-readable instructions to perform:
   detecting the presence of text in the live video feed in real-time;
   converting the detected text into machine-encoded text;
   retrieving the associated content by querying a database for storing machine-encoded text and associated content corresponding to the machine-encoded text based on the converted machine-encoded text; and
   superimposing the retrieved associated content in the form of Augmented Reality (AR) content on the live video feed;
wherein the computer-readable instructions of detection, conversion and superimposition are performed without user input to the mobile application.

In a fifth aspect, there is provided a server for recognising text using mobile devices with a built-in device video camera and automatically retrieving associated content based on the recognised text, the server comprising:
a data receiving unit to receive a data message from the mobile device, the data message containing a machine-encoded text that is detected and converted by an Optical Character Recognition (OCR) engine on the mobile device from a live video feed captured by the built-in device video camera in real-time; and
a data transmission unit to transmit a data message to the mobile device, the data message containing associated content retrieved from a database for storing machine-encoded text and the associated content corresponding to the machine-encoded text;
wherein the transmitted associated content is superimposed in the form of Augmented Reality (AR) content on the live video feed, and the detection and conversion by the OCR engine and the superimposition of the AR content is performed without user input.

The data receiving unit and the data transmission unit may be a Network Interface Card (NIC).

Advantageously, the platform minimises or eliminates any lag time experienced by the user because no sequential capture of still images using a virtual shutter button is required for recognising text in a live video feed. Also, the platform increases the probability of detecting text in a live video stream in a fast manner because users can continually and incrementally angle the mobile device (with the in-built device video camera) until a text recognition is made. Also, accuracy and performance for text recognition is improved because context is considered such as location of the mobile device. These advantages improve the user experience and enable further information to be retrieved relating to the user's present visual environment. Apart from advantages of users, the platform extends the advertising reach of businesses without requiring them to modify their existing advertising style, and increases their brand awareness to their target market by linking the physical world to their own generated digital content that is easier and faster to update. The platform also provides a convenient distribution channel for viral marketing to proliferate by bringing content from the physical world into the virtual world/Internet.

### BRIEF DESCRIPTION OF THE DRAWINGS

An example of the invention will now be described with reference to the accompanying drawings, in which:

FIG. 1 is a block diagram of a platform for recognising text using mobile devices with a built-in device video camera and retrieving associated content based on the recognised text;

FIG. 2 is a client side diagram of the platform of FIG. 1;

FIG. 3 is a server side diagram of the platform of FIG. 1;

FIG. 4 is a screenshot of the screen of the mobile device displaying AR content when detected text has been recognised by a mobile application in the platform of FIG. 1;

FIG. 5 is a diagram showing a tilting gesture when the mobile application of FIG. 4 is used for detecting text of an outdoor sign;

FIG. 6 is a screenshot of the screen of the mobile device showing settings that are selectable by the user;

FIG. 7 is a screenshot of the screen of the mobile device showing sub-applications that are selectable by the user; and

FIG. 8 is a process flow diagram depicting the operation of the mobile application.

### DETAILED DESCRIPTION OF THE DRAWINGS

The drawings and the following discussion are intended to provide a brief, general description of a suitable computing environment in which the present invention may be implemented. Although not required, the invention will be described in the general context of computer-executable instructions, such as program modules, being executed by a computer. Generally, program modules include routines, programs, characters, components, data structures that perform particular tasks or implement particular abstract data types. The invention may also be practiced in distributed computing environments where tasks are performed by remote processing devices that are linked through a communications network. In a distributed computing environment, program modules may be located in both local and remote memory storage devices.

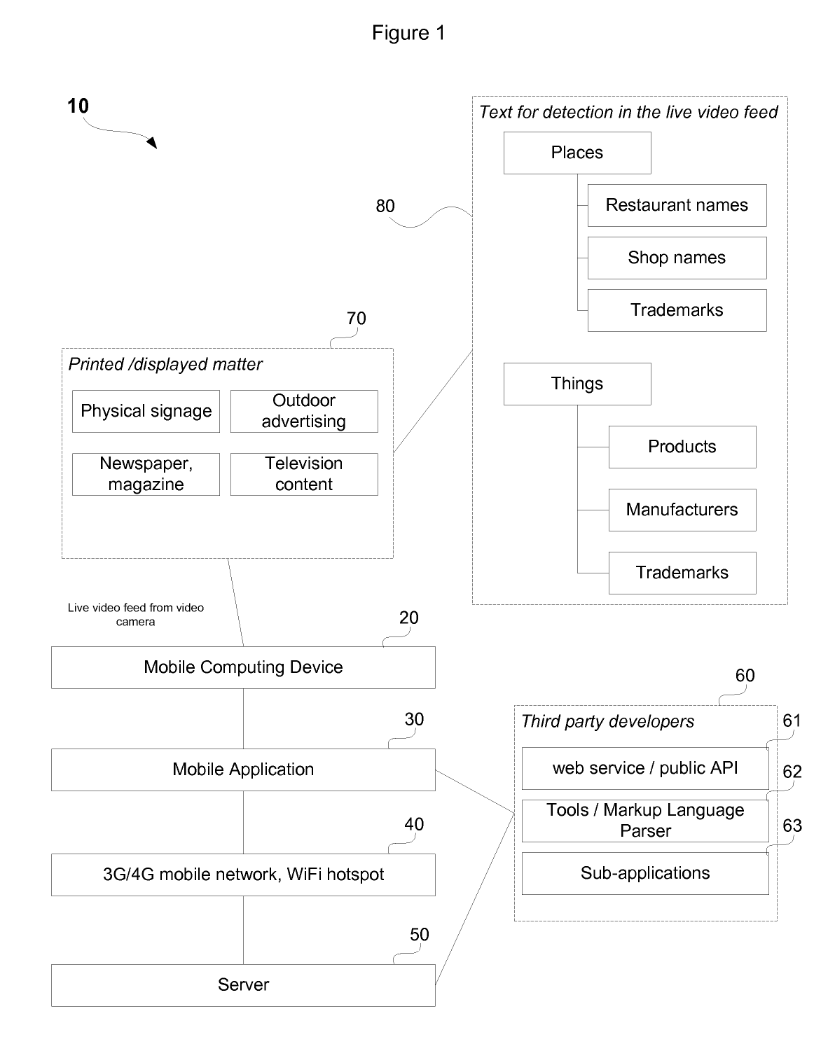

Referring to FIGS. 1 to 3, a platform 10 for recognising text using mobile devices 20 with a built-in device video camera 21 and automatically retrieving associated content based on the recognised text is provided. The platform 10 generally comprises: a database 51, an Optical Character Recognition (OCR) engine 32 and a mobile application 30. The database 35, 51 stores machine-encoded text and associated content corresponding to the machine-encoded text. The OCR engine 32 detects the presence of text in a live video feed 49 captured by the built-in device video camera 21 in real-time, and converts the detected text 41 into machine-encoded text in real-time. The mobile application 30 is executed by the mobile device 20.

The machine-encoded text is in the form of a word (for example, Cartier™ or a group of words (for example, Yung Kee Restaurant). The text markers 80 in the live video feed 49 for detection by the OCR engine 32 may be found on printed or displayed matter 70, for example, outdoor advertising, shop signs, advertising in printed media, or television or dynamic advertising light boxes. The text 80 may refer to places or things such as trade mark, logo, company name, shop/business name, brand name, product name or product model code. The text 80 in the live video feed 49 will generally be stylized, with color, a typeface, alignment, etc, and is identifiable by text markers 80 which indicate it is a written letter or character. In contrast, the machine-encoded text is in Unicode format or Universal Character Set, where each letter/character is stored as 8 to 16 bits on a computer. In terms of storage and transmission of the machine-encoded text, the average length of a word in the English language is 5.1, and hence the average size of each word of the machine-encoded text is 40.8 bits. Generally, business names and trade marks are usually less than four words.

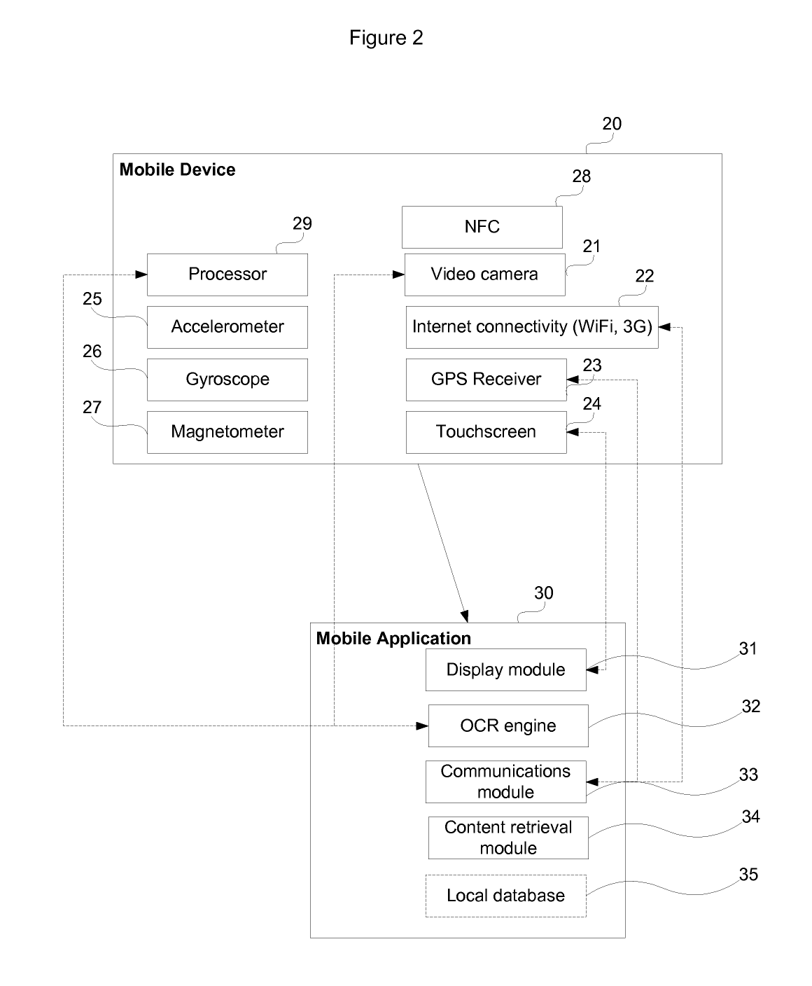

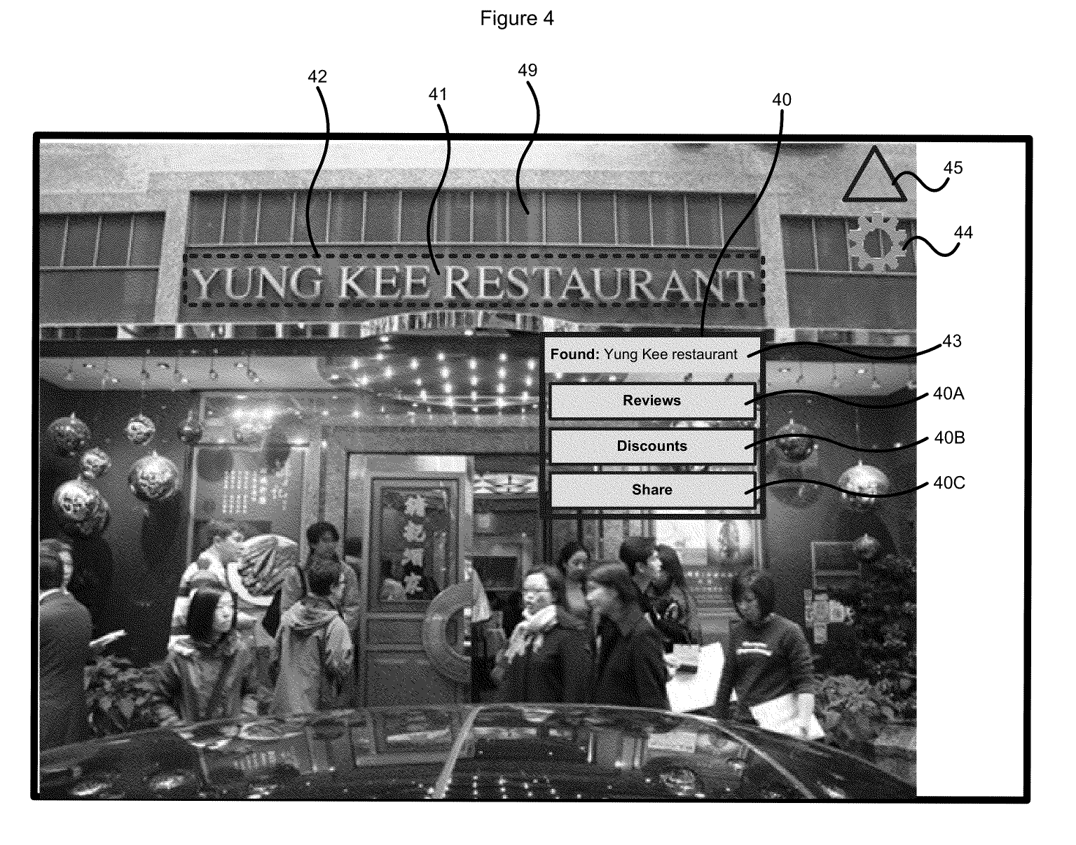

Referring to FIGS. 2 and 4, the mobile application 30 includes a display module 31 for displaying the live video feed 49 on the screen of the mobile device 20. The mobile application 30 also includes a content retrieval module 34 for retrieving the associated content by querying the database 35, 51 based on the machine-encoded text converted by the OCR engine 32. The retrieved associated content is superimposed in the form of Augmented Reality (AR) content 40 on the live video feed 49 using the display module 31. The detection and conversion by the OCR engine 32 and the superimposition of the AR content 40 is performed without user interaction on the screen of the mobile device 20.

The mobile device 20 includes a smartphone such as an Apple iPhone™, or a tablet computer such as an Apple iPad™. Basic hardware requirements of the mobile device 20 include a: video camera 21, WiFi and/or 3G data connectivity 22, Global Positioning Satellite receiver (GPSR) 23 and capacitive touchscreen panel display 24. Preferably, the mobile device 20 also includes: an accelerometer 25, gyroscope 26, a digital compass/magnetometer 27 and is Near Field Communication (NFC) 28 enabled. The processor 29 for the mobile device 20 may be an: Advanced Risc Machine (ARM) processor, package on package (PoP) system-on-a-chip (SoC), or single or dual core system-on-a-chip (SoC) with graphics processing unit (GPU).

The mobile application 30 is run on a mobile operating system such as iOS or Android. Mobile operating systems are generally simpler than desktop operating systems and deal more with wireless versions of broadband and local connectivity, mobile multimedia formats, and different input methods.

Referring back to FIG. 1, the platform 10 provides public Application Programming Interfaces (APIs) or web services 61 for third party developers 60 to interface with the system and use the machine-encoded text that was detected and converted by the mobile application 30. The public APIs and web services 61 enable third party developers 60 to develop a sub-application 63 which can interact with core features of the platform 10, including: access to the machine-encoded text converted by the OCR engine 32, the location of the mobile device 20 when the machine-encoded text was converted, and the date/time when the machine-encoded text was converted. Third party developers 60 can access historical data of the machine-encoded text converted by the OCR engine 32, and also URLs accessed by the user in response to machine-encoded text converted by the OCR engine 32. This enables them to enhance their sub-applications 63, for example, modify AR content 40 and URLs when they update their sub-applications 63. Sub-applications 63 developed by third parties can be downloaded by the user at any time if they find a particular sub-application 63 which suits their purpose.

It is envisaged that the default sub-applications 63 provided with the mobile application 30 are for more general industries such as places (food/beverage and shops), and products. Third party developed sub-applications 63 may include more specific/narrower industries such as wine appreciation where text on labels on bottles of wine are recognized, and the menu items 40 include information about the vineyard, user reviews of the wine, nearby wine cellars which stock the wine and their prices, or food that should be paired with the wine. Another sub-application 63 may be to populate a list such as a shopping/grocery list with product names in machine-encoded text converted by the OCR engine 32. The shopping/grocery list is accessible by the user later, and can be updated.

In the platform 10, every object in the system has a unique ID. The properties of each object can be accessed using a URL. The relationship between objects can be found in the properties. Objects include users, businesses, machine-encoded text, AR content 40, etc.

In one embodiment, the AR content 40 is a menu of buttons 40A, 40B, 40C as depicted in FIG. 4 displayed within a border 40 positioned proximal to the detected text 41 in the live video feed 49. The associated content is the AR content 40 and also the URLs corresponding to each button 40A, 40B, 40C. When a button 40A, 40B, 40C is pressed by the user, at least one web page is opened automatically. This web page is opened on an Internet browser on the mobile device 20. For example, if the “Reviews” button 40A is pressed, the web page that is automatically opened is: http://www.openrice.com/english/restaurants/sr2.htm?shopid=4203

which is web page containing user reviews of the restaurant on the Open Rice web site. Alternatively, the web page or digital content from the URL can be displayed in-line as AR content 40 meaning that a separate Internet browser does not need to be opened. For example, a video from YouTube can be streamed or a PDF file can be downloaded and displayed by the display module 31 and are superimposed on the live video feed 49, or an audio stream is played to the user while the live video feed 49 is active. Both the video and audio stream may be review or commentary about the restaurant.

Another example, is if the “Share” button 40C is pressed, another screen is displayed that is an “Upload photo” page to the user's Facebook account. The photo caption is pre-populated with the name and address of the restaurant. The user confirms the photo upload by clicking the “Upload” button on the “Upload photo” page. In other words, only two screen clicks are required by the user. This means social updates users of things they see is much faster and more convenient as less typing on the virtual keyboard is required.

If the detected text 41 is from an advertisement, then the AR content 40 may be a digital form of the same or varied advertisement and the ability to digitally share this advertisement using the “Share” button 40C with Facebook friends and Twitter subscribers extends the reach of traditional printed advertisements (outdoor advertising or on printed media). This broadening of reach incurs little or no financial cost for the advertiser because they do not have to change their existing advertising style/format or sacrifice advertising space for insertion of a meaningless QR code. This type of interaction to share interesting content within a social group also appeals with an Internet savvy generation of customers. This also enables viral marketing, and therefore the platform 10 becomes an effective distributor of viral messages.

Other URLs linked to AR content 40 include videos hosted on YouTube with content related to the machine-encoded text, review sites related to the machine-encoded text, Facebook updates containing the machine-encoded text, Twitter posts containing the machine-encoded text, discount coupon sites containing the machine-encoded text.

The AR content 40 can also include information obtained from the user's social network from their accounts with Facebook, Twitter and FourSquare. If contacts their social network have mentioned the machine-encoded text at any point in time, then these status updates/tweets/check-ins are the AR content 40. In other words, instead of reviews from people the user does not know from review sites, the user can see personal reviews. This enables viral marketing.

In one embodiment, the mobile application 30 includes a markup language parser 62 to enable a third party developer 60 to specify AR content 40 in response to the machine-encoded text converted by the OCR engine 32. The markup language parser 62 parses a file containing markup language to render the AR content 40 in the mobile application 30. This tool 62 is provided to third party developers 60 so that the look and feel of third party sub-applications 63 appear similar to the main mobile application 30. Developers 60 can use the markup language to create their own user interface components for the AR content 40. For example, they may design their own list of menu items 40A, 40B, 40C, and specify the colour, size and position of the AR content 40. Apart from defining the appearance of the AR content 40, the markup language can specify the function of each menu item 40A, 40B, 40C. For example, the URL of each menu item 40A, 40B, 40C and destination target URLs

Users may also change the URL for certain menu items 40A, 40B, 40C according to their preferences. For example, instead of uploading to Facebook when the “Share” button 40C is pressed, they may decide to upload to another social network such as Google+, or a photo sharing site such as Flickr or Picasa Web Albums.

For non-technical developers 60 such as business owners, a web form is provided so they may change existing AR content 40 templates without having to write code in the markup language. For example, they may change the URL to a different a web page that is associated to a machine-encoded text corresponding to their business name. This gives them greater control to operate their own marketing, if they change the URL to a web page for their current advertising campaign. They may also upload an image to the server 50 of their latest advertisement, shop sign or logo and associate it with machine-encoded text and a URL.

Apart from a menu, other types of AR content 40 may include a star rating system, where a number of stars out of a maximum number of stars is superimposed over the live video feed 49, and its position is relative to the detected text 41 to quickly indicate the quality of the good or service. If the rating system is clicked, it may open a web page of the ratings organisation which explains how and why it achieved that rating.

If the AR content 40 is clickable by the user, then the clicks can be recorded for statistical purposes. The frequency of each AR content item 40A, 40B, 40C selected by the total user base is recorded. Items 40A, 40B, 40C which are least used can be replaced with other items 40A, 40B, 40C, or eliminated. This removes clutter from the display and improves the user experience by only presenting AR content 40 that is relevant and proved useful. By recording the clicks, further insight into the intention of the user for using the platform 10 is obtained.

The position of the AR content 40 is relative to the detected text 41. Positioning is important because the intention is to impart a contextual relationship between the detected text 41 and the AR content 40, and also to avoid obstructing or obscuring the detected text 41 in the live video feed 49.

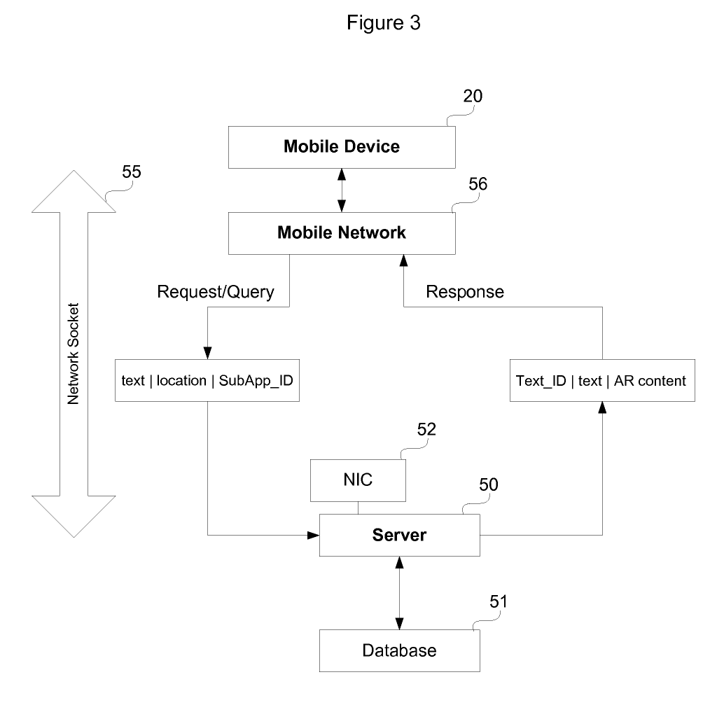

Although the database 35 may be stored on the mobile device 20 as depicted in FIG. 2, in another embodiment FIG. 3 depicts it may be remotely stored 51 and accessed via the Internet. The choice of location for the database 35, 51 may be dependent on many factors, for example, size of the database 35, 51 and the storage capacity of the mobile device 20, or the need to have a centralised database 51 accessible by many users. A local database 35 may avoid the need for 3G connectivity. However, the mobile application 30 must be regularly updated to add new entries into the local database 35. The update of the mobile application 30 would occur the next time the mobile device 20 is connected via WiFi or 3G to the Internet, and then a server could transmit the update to the mobile device 20.

Preferably, the database 35, 51 is an SQL database. In one embodiment, the database 35, 51 has at least the following tables:

| Table Name | Purpose |
|---|---|
| Text Table | Store Text_ID with machine-encoded text, location |
| AR Table | Store AR_ID with AR content 40 to display (mark-up |
| | language) |
| SubApp Table | Store SubApp_ID for recording third party sub- |
| | applications 63 |
| User Table | Store User_ID for recording user details |
| Gesture Table | Store Gesture_ID for recording gestures holding the |
| | mobile device to interact with the AR content 40 |
| | without touchscreen contact |
| History Table | Store the AR content 40 ID that has been clicked with |
| | User_ID, with date/time and location |

The communications module 33 of the mobile application 30 opens a network socket 55 between the mobile device 20 and the server 50 over a network 56. This is preferred to discrete requests/responses from the server 50 because faster responses from the server 50 will occur using an established connection. For example, the CFNetwork framework can be used if the mobile operating system is iOS to communicate across network sockets 55 via a HTTP connection. The network socket 55 may be a TCP network socket 55. A request is transmitted from the mobile device 20 to the server 50 to query the database 51. The request contains the converted machine-encoded text along with other contextual information including some or all of the following: the GPS co-ordinates from the GPSR 23 and the sub-application(s) 63 selected. The response from the database 35, 51 is a result includes the machine-encoded text from the database 51 and the AR content 40.

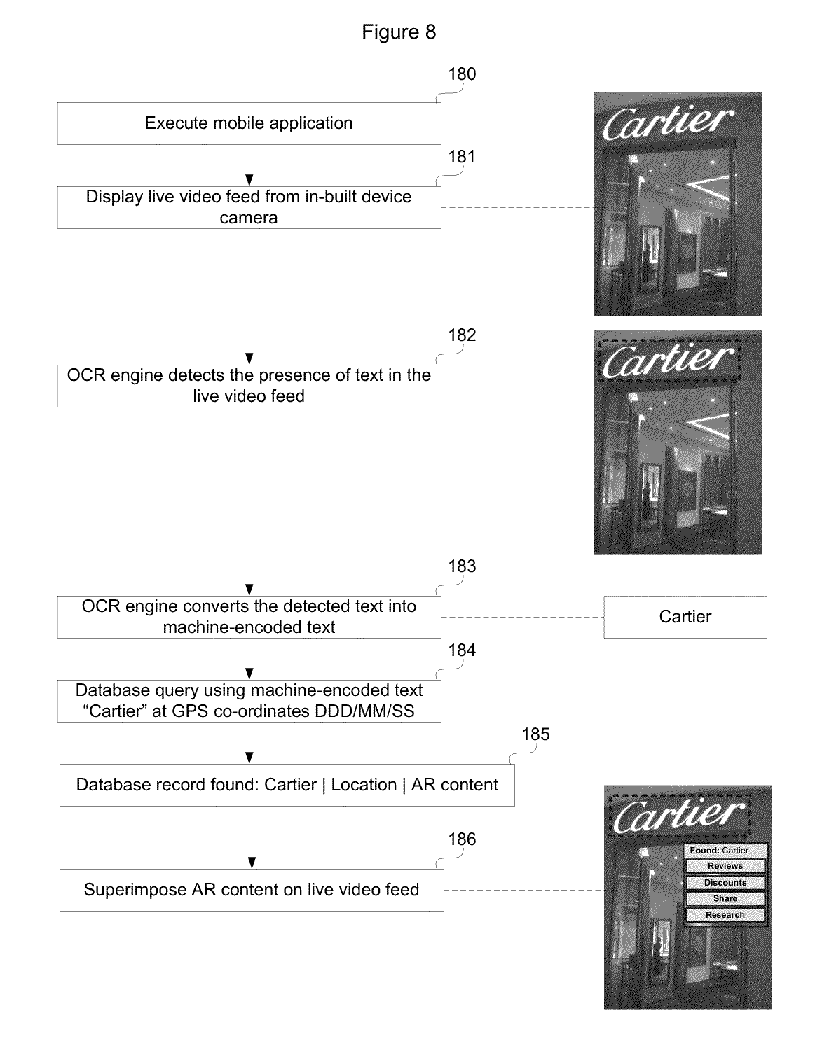

Referring to FIGS. 4 and 8, in a typical scenario, when the mobile application 30 is executed (180), the built-in device video camera 21 is activated and a live video feed 49 is displayed (181) to the user. Depending on the built-in device video camera 21 and lighting conditions, the live video feed 49 is displayed 24 to 30 frames per second on the touchscreen 24. The OCR engine 32 immediately begins detecting (182) text in the live video feed 49 for conversion into machine-encoded text.

The detected text 41 is highlighted with a user re-sizable border/bounding box 42 for cropping a sub-image that is identified as a Region of Interest in the live video feed 49 for the OCR engine 32 to focus on. The bounding box 42 is constantly tracked around the detected text 41 even when there is slight movement of the mobile device 20. If the angular movement of the mobile device 20, for example, caused by hand shaking or natural drift is within a predefined range, the bounding box 42 remains focused around detected text 41. Video tracking is used but in terms of the mobile device 20 being the moving object relative to a stationary background. To detect another text which may or may not be in the current live video feed 49, the user has to adjust the angular view of the video camera 21 beyond the predefined range and within a predetermined amount of time. It is assumed that the user is changing to another detection of text when the user makes a noticeable angular movement of the mobile device 20 at a faster rate. For example if the user pans the angular view of the mobile device 20 by 30° to the left within a few milliseconds, this indicates they are not interested in the current detected text 41 in the bounding box 42 and wishes to recognise a different text marker 80 somewhere else to the left of the current live video feed 49.

When the OCR engine 32 has detected text 41 in the live video feed 49, it converts (183) it into machine-encoded text and a query (184) on the database 35, 51 is performed. The database query matches (185) a unique result in the database 35, 51, and the associated AR content 40 is retrieved (186). A match in the database 35, 51 causes the machine-encoded text to be displayed in the “Found:” label 43 in the superimposed menu. The Found:” label 43 automatically changes when subsequent detected text in the live video feed 49 is successfully converted by the OCR engine 32 into machine-encoded text that is matched in the database 35, 51. If the AR content 40 is a list of relevant menu items 40A, 40B, 40C, menu labels and underlying action for each menu item 40A, 40B, 40C are returned from the database query in an array or linked list. The menu items 40A, 40B, 40C are shown below the “Found: [machine-encoded text]” label 43. Each menu item 40A, 40B, 40C can be clicked to direct the user to a specific URL. When a menu item 40A, 40B, 40C is clicked, the URL is automatically opened in an Internet browser on the mobile device 20.

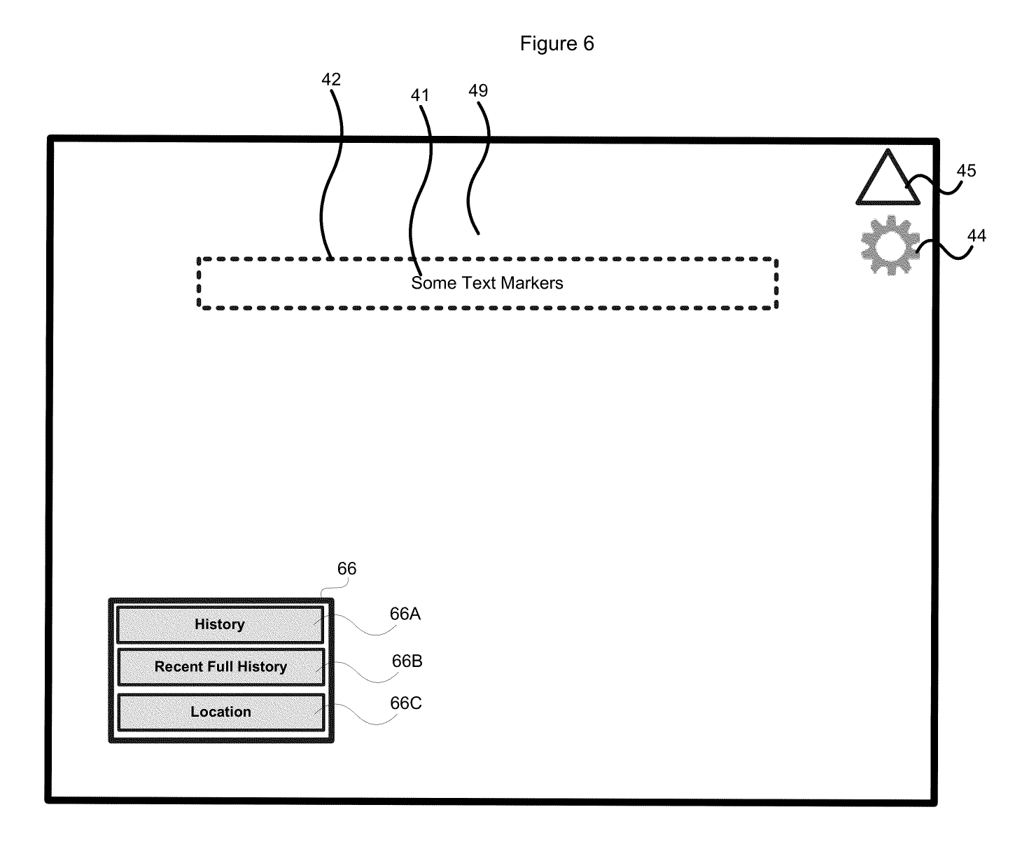

Referring to FIG. 6, clicking on the settings icon 44 superimposes a menu 66 that lists items corresponding to: History 66A, Recent Full History 66B and Location 66C. The History item 66A displays converted text when an AR content item 40A, 40B, 40C was selected. This is a stronger indication that the user obtained the information they wanted rather than all detected text 41 found by the OCR engine 32 because the user ultimately clicked on an AR content item 40A, 40B, 40C. If the user clicks on any of the previous converted text shown in the History item list, a database query is performed, and the AR content 40 is displayed again, for example, the list of menu items 40A, 40B, 40C. The Recent Full History item 66B displays all detected text 41 whether any menu items 40A, 40B, 40C were clicked on or not. Both History 66A and Recent Full History 66B enable the detected text 41 to be copied to the clipboard if the user wishes to use them for a manual or broader search using a web-based search engine in their Internet browser. The Location item 66C enables the user to manually set their location if they do not wish to use the GPS co-ordinates from the GPSR 23.

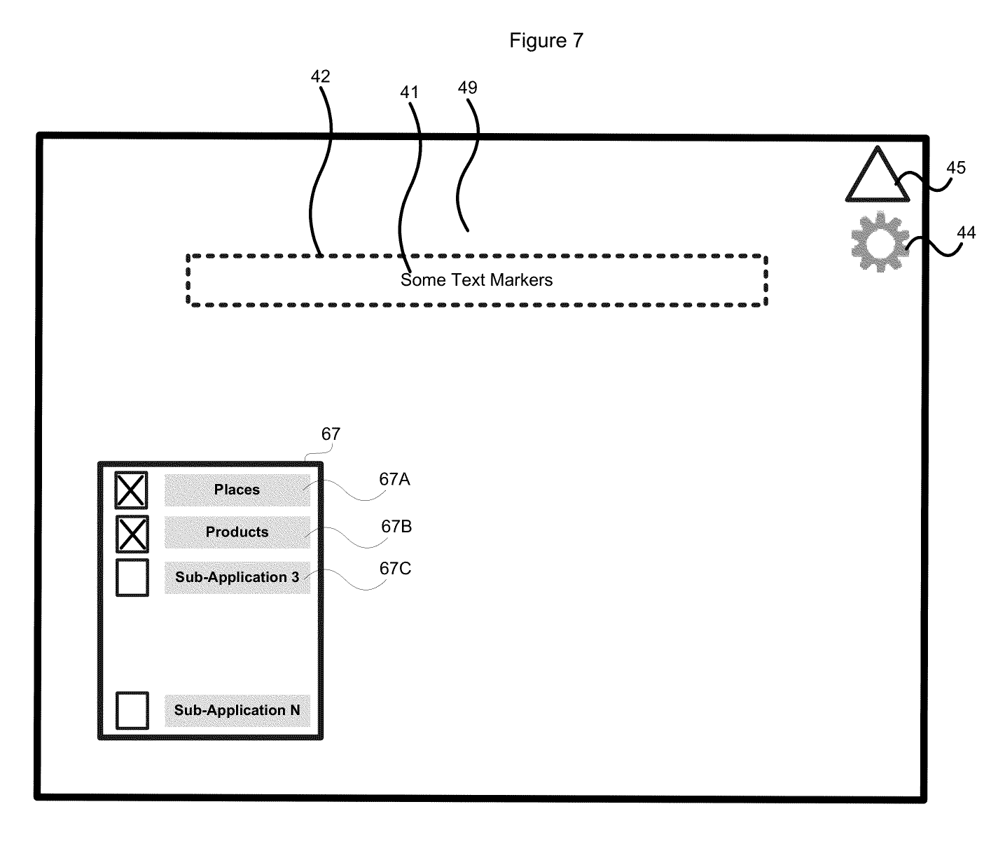

Referring to FIG. 7, clicking on a sub-application icon 45 superimposes a menu 67 listing items 67A, 67B, 67C corresponding to sub-applications 63 installed for the mobile application 30. The default setting may be the last sub-application 63 that was used by the user, or mixed mode. Mixed mode means that text detection and conversion to machine-encoded text will not be limited to a single sub-application 63. This may slow down performance as a larger proportion of the database 35, 51 is searched. Mixed mode can be adjusted to cover two or more sub-applications 63 by the user marking check boxes displayed in the menu 67. This is useful if the user is not familiar whether they are intending on detecting a business name or a product name in the live video feed 49.

Both the Apple iPhone 4S™ and Samsung Galaxy S II™ smartphones have an 8 megapixel in-built device camera 21, and provide a live video feed at 1080p resolution (1920×1080 pixels per frame) at a frame rate of 24 to 30 (outdoors sunlight environment) frames per second. Most mobile devices 20 such as the Apple iPhone 4S™ feature image stabilization to help mitigate the problems of a wobbly hand as well as temporal noise reduction (to enhance low-light capture). This image resolution is provides sufficient detail for text markers in the live video feed 49 to be detected and converted by the OCR engine 32.

Typically, a 3G network 56 enables data transmission from the mobile device 20 at 25 Kbit/sec to 1.5 Mbit/sec, and a 4G network enables data transmission from the mobile device 20 at 6 Mbit/sec. If the live video feed 49 is 1080p resolution, each frame is 2.1 megapixels and after JPEG image compression, the size of each frame may be reduced to 731.1 Kb. Therefore each second of video has a data size of 21.4 Mb. It is currently not possible to transmit this volume of data over a mobile network 56 quickly enough to provide a real-time effect, and hence the user experience is diminished. Therefore currently it is preferable to perform the text detection and conversion using the mobile device 20 as this would deliver a real-time feedback experience for the user. In one embodiment of the platform 10 using a remote database 51, only a database query containing the machine-encoded text is transmitted via the mobile network 56 which will be less than 5 Kbit and hence only a fraction of a second is required for the transmission time. The returning results from the database 51 are received via the mobile network 56 and the receiving time is much faster, because the typical 3G download rate is 1 Mbit/sec. Therefore although the AR content 40 retrieved from the database 51 is larger than the database query, the faster download rate means that the user enjoys a real-time feedback experience. Typically, a single transmit and returning results loop is completed in milliseconds achieving a real-time feedback experience. To achieve faster response, it may be possible to pre-fetch AR content 40 from the database 51 based on the current location of the mobile device 20.

The detection rate for the OCR engine 32 is higher than general purpose OCR or intelligent character recognition (ICR) systems. The purpose of ICR is handwriting recognition which contains personal variations and idiosyncrasies even in the same block of text, meaning there is lack of uniformity or a predictive pattern. The OCR engine 32 of the platform 10 detects non-cursive script, and the text to be detected generally conforms to a particular typeface. In other words, a word or group of words for a shop sign, company or product logo is likely to conform to the same typeface.

Other reasons for a higher detection rate by the OCR engine 32 include:
the text to be detected is stationary in the live video feed 49, for example, the text is a shop sign or in an advertisement, and therefore only angular movement of the mobile device 20 needs to be compensated for;
signage and advertisements are generally written very clearly with good colour contrast from the background;
signage and advertisements are generally written correctly and accurately to avoid spelling mistakes;
shop names are usually illuminated well in low light conditions and visible without a lot of obstruction;
edge detection of letters/character and uniform spacing and applying a flood fill algorithm;
pattern matching to the machine-encoded text in the database 35, 51 using probability of letter/character combinations and applying the best-match principle even when letters of a word/stroke of a character is missing or cannot be recognised;
the database 35, 51 is generally smaller in size than a full dictionary, especially for brand names which are coined words;
the search of the database 35, 51 can be further restricted if the user has indicated the sub-application 63(s) to use;
Region of Interest (ROI) finding to only analyse a small proportion of a video frame as the detection is for one or a few words in the entire video frame;
an initial assumption that the ROI is approximately at the center of the screen of the mobile device 20;
a subsequent assumption (if necessary) that the largest text markers 80 detected in the live video feed 49 are most likely to be the one desired by the user for conversion into machine encoded text;
detecting alignment of text markers 80 in a straight line because generally words for shop names are written in a straight line, but if no text is detected, then detect for alignment of text markers 80 based on regular geometric shapes like an arc or circle;
detecting uniformity in colour and size as shop names and brand names are likely to be written in the same colour and size; and
applying filters to remove background imagery if large portions of the image are continuous with the same colour, or if there is movement in the background (e.g. people walking) which is assumed not to be stationary signage.

The machine-encoded text and AR content 40 are superimposed in the live video feed 49. The OCR engine 32 is run in a continual loop until the live video feed 49 is no longer displayed, for example, when the user clicks on the AR content 40 and a web page in an Internet browser is opened. Therefore, instead of having to press the virtual shutter button over and over again with delay, the user simply needs to make an angular movement (pan, tilt, roll) to their mobile device 20 until the OCR engine 32 detects text in the live video feed 49. This avoids any touchscreen interaction, is more responsive and intuitive and ultimately improves the user experience.

The OCR engine 32 for the platform 10 is not equivalent to an image recognition engine which attempts to recognise all objects in an entire image. Image recognition in real-time is very difficult because the number of objects in a live video feed 49 is potentially infinite and therefore the database 35, 51 has to be very large and a large database load is incurred. In contrast, text has a finite quantity, because human languages use characters repeatedly to communicate. There are alphabet based writing systems including the Latin alphabet, That alphabet and Arabic alphabet. For logographic based writing systems, Chinese has approximately 106,230 characters, Japanese has approximately 50,000 characters and Korean has approximately 53,667 characters.

The OCR engine 32 for the platform 10 may be incorporated into the mobile application 30, or it may be a standalone mobile application 30, or integrated as an operating system service.

Preferably, all HTTP requests to external URLs linked to AR content 40 from the mobile application 30 passes through a gateway server 50. The server 50 has at least one Network Interface Card (NIC) 52 to receive the HTTP requests and to transmit information to the mobile devices 30. The gateway server 50 quickly extracts and strips certain information on the incoming request before re-directing the user to the intended external URL. Using a gateway server 50 enables quality of service monitoring and usage monitoring which are used to enhance the platform 10 for better performance and ease of use in response to actual user activity. The information extracted by the gateway server 50 from an incoming request include non-personal user data, location of the mobile device 20 at the time the AR content 40 is clicked, date/time the AR content 40 is clicked, the AR content 40 that was clicked, and the machine-encoded text. This extracted information is stored for statistical analysis which can be monitored in real-time or analysed as historical data over a predefined time period.

The platform 10 also constructs a social graph for mobile device 20 users and businesses, and is not limited to the Internet users or the virtual world like the social graph of the Facebook platform 10 is. The social graph may be stored in a database. The network of connections and relationships between mobile device 20 users (who are customers or potential customers) using the platform 10 and businesses (who may or may not actively use the platform 10) is mapped. Objects such as mobile device 20 users, businesses, AR content 40, URLs, locations and date/time of clicking the AR content 40 are uniformly represented in the social graph. A public API/web service to access the social graph enables businesses to market their goods and services more intelligently to existing customers and reach potentially new customers. Similarly for third party developers 60, they can access the social graph to gain insight into the interests of users and develop sub-applications 63 of the platform 10 to appeal to them. A location that receives many text detects can increase its price for outdoor advertising accordingly. If the outdoor advertising is digital imagery like an LED screen which can be dynamically changed, then the data of date/time of clicking the AR content 40 is useful because pricing can be changed for the time periods that usually receive more clicks than other times.

In order to improve the user experience, other hardware components of the mobile device 20 can be used including the accelerometer 25, gyroscope 26, magnetometer 27 and NFC.

When a smartphone is held in portrait screen orientation only graphical user interface (GUI) components in the top right portion or bottom left portion of the screen can be easily touched by the thumb for a right handed person, because rotation of an extended thumb is easier than rotation of a bent thumb. For a left handed person, it is the top left portion or bottom right portion of the screen. At most, only four GUI components (icons) can be easily touched by an extended thumb while firmly holding the smartphone. Alternatively, the user must use their other hand to touch the GUI components on the touchscreen 24 which is undesirable if the user requires the other hand for some other activity. In landscape screen orientation, it is very difficult to firmly hold the smartphone on at least two opposing sides and use any fingers of the same hand to touch GUI components on the touchscreen 24 while not obstructing the lens of the video camera 21 or a large portion of the touchscreen.

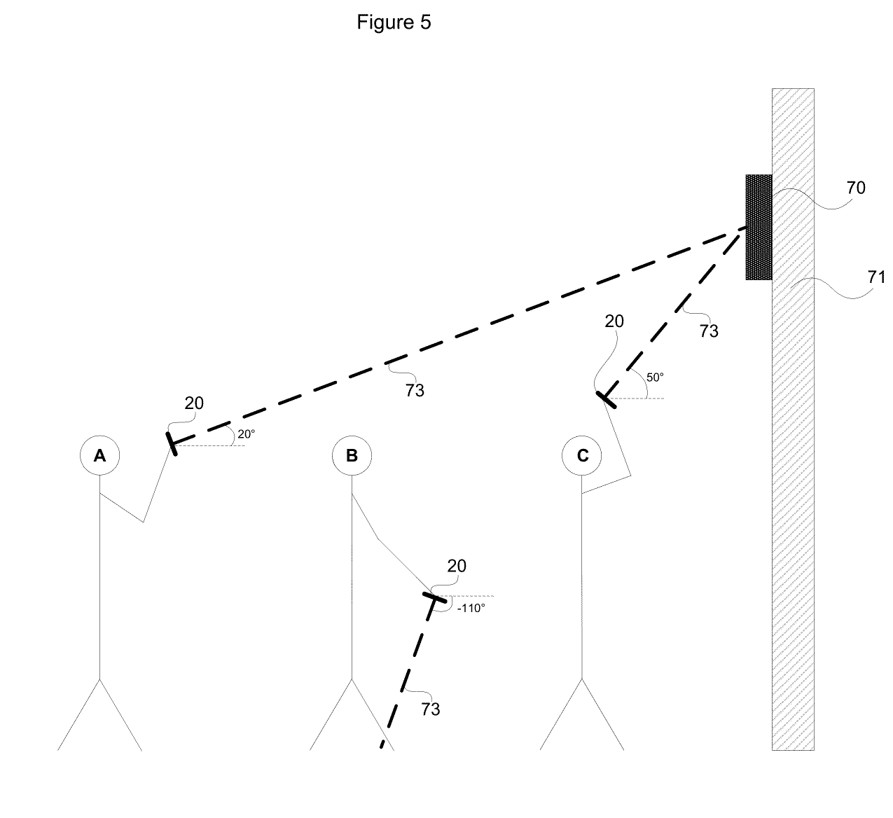

Referring to FIGS. 2 and 5, outdoor signage 70 is usually positioned at least 180 cm above the ground to maximise exposure for pedestrian and vehicular traffic. Users A and C have held their mobile device 20 at positive angles, 20° and 50°, respectively, in order for the sign 70 containing the text to be in the angle of view 73 of the camera 21 for the live video feed 49. The sign 70 is positioned usually above a shop 71 or a structural frame 71 if it is a billboard. Using the measurement readings from the accelerometer 25 can reduce user interaction with the touchscreen 24, and therefore enable one handed operation of the mobile device 20. For example, instead of touching a menu item on the touchscreen 24, the user may simply tilt the smartphone 20 down such that camera 21 faces the ground to indicate a click on an AR content item 40A, 40B, 40C such as the “Reviews” button 40A, for example, user B has tilted the smartphone 20 down to −110°. The accelerometer 25 measures the angle via linear acceleration, and the rate of tilting can be detected by the gyroscope 26 by measuring the angular rate. A rapid downward tilt of the smartphone 20 towards the ground is a user indication to perform an action by the mobile application 30. The user can record this gesture to correspond with the action of clicking the “Reviews” button 40A, or the first button presented in the menu that is the AR content 40. It is envisaged other gestures when the mobile device 20 is held can be recorded for corresponding actions with the mobile application 30, for example, quick rotation of the mobile device 20 in certain directions.

Apart from video tracking, the measurement readings of the accelerometer 25 and gyroscope 26 can indicate whether the user is trying to keep the smartphone steady to focus on an area in the live video feed 49 or wanting to change the view to focus on another area. If the movement measured by the accelerometer 25 is greater than a predetermined distance and the rate of movement measured by the gyroscope 26 is greater than a predetermined amount, this is a user indication to change current view to focus on another area. Therefore, the OCR engine 32 may temporarily stop detecting text in the live video feed 49 until the smartphone becomes steady again, or it may perform a default action on the last AR content 40 displayed on the screen. A slow panning movement of the smartphone is a user indication for the OCR engine 32 to continue to detect text in the live video feed 49. The direction of panning indicates to the OCR engine 32 that the ROI will be entering from that direction so less attention will be given to text markers 80 leaving the live video feed 49. Panning of the mobile device 20 may occur where there are a row of shops situated together on a street or advertisements positioned closely to each other.

Most mobile devices 20 also have a front facing built-in device camera 21. A facial recognition module will detect whether the left, right or both eyes have momentarily closed, and therefore three actions for interacting with the AR content 40 can be mapped to these three facial expressions. Another two actions can be mapped to facial expressions where an eye remains closed for a time period longer than a predetermined duration. It is envisaged more facial expressions can be used to map to actions with the mobile application 30, such as tracking of eyeball movement to move a virtual cursor to focus on a particular button 40A, 40B, 40C.

If the mobile device 20 has a microphone, for example, a smartphone, it can be used to interact with the mobile application 30. A voice recognition module is activated to listen for voice commands from the user where each voice command is mapped to an action for interacting with the AR content 40, like selecting a specific AR content item 40A, 40B, 40C.

The magnetometer 27 provides the cardinal direction of the mobile device 20. In the outdoor environment, the mobile application 30 is able to ascertain what is being seen in the live video feed 49 based on Google Maps™, for example, the address of a building because a GPS location only provides an approximate location within 10 to 20 meters, and the magnetometer 27 provides the cardinal direction so a more accurate street address can be identified from a map. A more accurate street address assists in the database query by limiting the context further than only the reading from the GPSR 23.

Uncommon hardware components for mobile devices 20 are: an Infrared (IR) laser emitter/IR filter and pressure altimeter. These components can be added to the mobile device 20 after purchase or included in the next generation of mobile devices 20.

The IR laser emitter emits a laser that is invisible to human eye from the mobile device 20 to highlight or pin point a text marker 80 on a sign or printed media. The IR filter (such as a ADXIR lens) enables the IR laser to be seen in on the screen of the mobile device 20. By seeing the IR laser point on the target, the OCR engine 32 has a reference point to start detecting text in the live video feed 49. Also, in some scenarios where there may be a lot of text markers 80 in the live video feed 49, the IR laser can be used by the user to manually direct the area for text detection.

A pressure altimeter is used to detect the height above ground/sea level by measuring the air pressure. The mobile application 30 is able to ascertain the height and identify the floor of building the mobile device 20 is on. Useful if the person is in a building to identify the exact shop they are facing. A more accurate shop address with the floor level would assist in the database query by limiting the context further than only the reading from the GPSR 23.

Two default sub-applications 63 are pre-installed with the mobile application 30, which are: places (food & beverage/shopping) 67A and products 67B. The user can use these immediately after installing the mobile application 30 on their mobile device 20.

Places

| Text to detect | AR content 40 | AR Link |
|---|---|---|
| Name of the food & | Reviews | Openrice |
| beverage establishment | Share | Facebook, Twitter |
| | Discounts | Groupon, Credit Card |
| | | Discounts |
| | Star rating | Zagat |
| Name of shop | Reviews | Fodors, TripAdvisor |
| | Share | Facebook, Twitter |
| | Discounts | Groupon, Credit Card |
| | | Discounts |
| | Shop's Advertising | Shop's URL, YouTube |
| | campaign | |
| | Research | Wikipedia |

Products

| Text to detect | AR content 40 | AR Link |
|---|---|---|
| Product/Model Number | Reviews | CNet, ConsumerSearch, |
| | | Epinions.com |
| | Share | Facebook, Twitter |
| | Discounts | Groupon, Credit Card |
| | | Discounts |
| | Price Comparison | www.price.com.hk |
| | | Google Product Search |
| | | www.pricegrabber.com |
| | Product Information | Manufacturer's URL, |
| | | YouTube |
| Product Name | Reviews | CNet, ConsumerSearch, |
| | | Epinions.com |
| | Share | Facebook, Twitter |
| | Discounts | Groupon, Credit Card |
| | | Discounts |
| | Price Comparison | www.price.com.hk |
| | | Google Product Search |
| | | www.pricegrabber.com |
| | Product Information | Manufacturer's URL, |
| | | YouTube |
| Movie Name | Review | IMDB, RottenTomatos |
| | Movie Information | Movie's URL |
| | Trailer | YouTube |
| | Ticketing | Cinema's URL |

Although a mobile application 30 has been described, it is possible that the present invention is also provided in the form a widget located on an application screen of the mobile device 20. A widget is an active program visually accessible by the user usually by swiping the application screens of the mobile device 20. Hence, at least some functionality of the widget is usually running in the background at all times.

The term real-time is interpreted to mean the detection of text in the live video feed 49 and its conversion by the OCR engine 32 into machine-encoded text and the display of AR content 40 is processed within a very small amount time (usually milliseconds) so that it is available virtually immediately as visual feedback to the user. Real-time in the context of the present invention is preferably less than 2 seconds, and more preferably within milliseconds such that any delay in visual responsiveness is unnoticeable to the user.

It will be appreciated by persons skilled in the art that numerous variations and/or modifications may be made to the invention as shown in the specific embodiments without departing from the scope or spirit of the invention as broadly described.

The present embodiments are, therefore, to be considered in all respects illustrative and not restrictive.

We claim:

1. A platform for recognising text using mobile devices with a built-in device video camera and automatically retrieving associated content based on the recognised text, the platform comprising:
a database for storing machine-encoded text and associated content corresponding to the machine-encoded text; and
a text detection engine for detecting the presence of text in a live video feed captured by the built-in device video camera in real-time, and converting the detected text into machine-encoded text in real-time; and
a mobile application executed by the mobile device, the mobile application including: a display module for displaying the live video feed on a screen of the mobile device; and a content retrieval module for retrieving the associated content by querying the database based on the machine-encoded text converted by the text detection engine;
wherein the retrieved associated content is superimposed in the form of Augmented Reality (AR) content on the live video feed in real-time using the display module, the AR content having user-selectable graphical user interface components that when selected by a user retrieves digital content remotely stored from the mobile device, and the detection and conversion by the text detection engine and the superimposition of the AR content is performed without user input to the mobile application.

2. The platform according to claim 1, wherein each user-selectable graphical user interface components is selected by the user by performing any one from the group consisting of: touching the user-selectable graphical user interface component displayed on the screen, issuing a voice command and moving the mobile device in a predetermined manner.

3. The platform according to claim 1, wherein the text detection engine is an Optical Character Recognition (OCR) engine.

4. The platform according to claim 1, wherein the user-selectable graphical user interface contents includes at least one menu item that when selected by a user, enables at least one web page to be opened automatically.

5. The platform according to claim 1, wherein the database is stored on the mobile device, or remotely stored and accessed via the Internet.

6. The platform according to claim 1, wherein the mobile application has at least one graphical user interface component to enable a user to:
manually set language of text to be detected in the live video feed;
manually set geographic location to reduce the number of records to be searched in the database,
manually set at least one sub-application to reduce the number of records to be searched in the database,
view history of detected text, or
view history of associated content selected by the user.

7. The platform according to claim 6, wherein the sub-application is any one from the group consisting of: place and product.

8. The platform according to claim 6, wherein the query of the database further comprises:
geographic location and at least one sub-application that are manually set by the user; or
geographic location obtained from a Global Positioning Satellite receiver (GPSR) of the mobile device and at least one sub-application that are manually set by the user.

9. The platform according to claim 1, wherein the display module displays a re-sizable bounding box around the detected text to limit a Region of Interest (ROI) in the live video feed.

10. The platform according to claim 1, wherein the position of the superimposed associated content is relative to the position of the detected text in the live video feed.

11. The platform according to claim 1, wherein the mobile application further includes the text detection engine, or the text detection engine is provided in a separate mobile application that communicates with the mobile application.

12. The platform according to claim 3, wherein the OCR engine assigns a higher priority for:
detecting the presence of text located in an area at a central region of the live video feed;
detecting the presence of text for text markers that are aligned relative to a single imaginary straight line, with substantially equal spacing between individual characters and substantially equal spacing between groups of characters, and with the substantially the same font; and
detecting the presence of text for text markers that are the largest size in the live video feed.

13. The platform according to claim 12, wherein the text markers include any one from the group consisting of: spaces, edges, colour, and contrast.

14. The platform according to claim 1, further comprising a web service to enable a third party developer to modify the database or create a new database.

15. The platform according to claim 1, where the mobile application further includes a markup language parser to enable a third party developer to specify AR content in response to the machine-encoded text converted by the text detection engine.

16. The platform according to claim 4, wherein information is transmitted to a server containing non-personally identifiable information about a user, geographic location of the mobile device, time of detected text conversion, machine-encoded text that have been converted and the menu item that was selected, before the server re-directs the user to at least one the web page.

17. A mobile application executed by a mobile device for recognising text using a built-in device video camera of the mobile device and automatically retrieving associated content based on the recognised text, the application comprising:
a display module for displaying a live video feed captured by the built-in device video camera in real-time on a screen of the mobile device; and
a content retrieval module for retrieving the associated content from a database for storing machine-encoded text and associated content corresponding to the machine-encoded text by querying the database based on the machine-encoded text converted by an text detection engine for detecting the presence of text in the live video feed captured and converting the detected text into machine-encoded text in real-time;
wherein the retrieved associated content is superimposed in the form of Augmented Reality (AR) content on the live video feed in real-time using the display module, the AR content having user-selectable graphical user interface components that when selected by a user retrieves digital content remotely stored from the mobile device, and the detection and conversion by the text detection engine and the superimposition of the AR content is performed without user input to the mobile application.

18. A computer-implemented method for recognising text using a mobile device with a built-in device video camera and automatically retrieving associated content based on the recognised text, the method comprising:
displaying a live video feed on a screen of the mobile device captured by the built-in device video camera of the mobile device in real-time;
detecting the presence of text in the live video feed;
converting the detected text into machine-encoded text;
retrieving the associated content by querying a database for storing machine-encoded text and associated content corresponding to the machine-encoded text based on the converted machine-encoded text; and
superimposing the retrieved associated content in the form of Augmented Reality (AR) content on the live video feed in real-time, the AR content having user-selectable graphical user interface components that when selected by a user retrieves digital content remotely stored from the mobile device;
wherein the steps of detection, conversion and superimposition are performed without user input to the mobile application.
